(19) United States
(12) Patent Application Publication
(10) Pub. No.: US 2004/0245381 A1
(43) Pub. Date: Dec. 9, 2004

(54) Hot gas valve with fibrous monolith ceramic

(76) Inventors: Jason A. Gratton, Chandler, AZ (US); Don L. Mittendorf, Mesa, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/440,327

(22) Filed: May 16, 2003

(51) Int. Cl. B64B 1/36

(52) U.S. Cl. 244/52

(57) ABSTRACT

A valve is disclosed for use in hot gas applications such as in rocket or missile engine systems or the like. The valve is designed to withstand the extreme temperatures encountered in the gas exhaust from rocket propellants. The valve seat of the valve is constructed of fibrous monolith ceramic. This material does not degrade significantly when rocket exhaust, such as resulting when ammonium perchlorate propellant is burned, is ported through the valve. The valve generally includes a valve body, a valve seat, through which gases may pass, and a poppet which opens and closes the valve by pressing against and moving away from the valve seat.

### FIELD OF THE INVENTION

The present invention relates generally to hot gas valves; and more particularly, the invention relates to materials for constructing valve components such as valve seats that operate in a hot gas environment such as that encountered in rocket or missile engines or the like.

### BACKGROUND OF THE INVENTION

Rockets, missiles, and other vehicles that travel through and outside the earth's atmosphere can experience severe operating conditions. Temperature extremes are one kind of harsh condition that vehicle design and component design must address. Temperatures in space approach absolute zero. However, certain vehicle parts, including for example, valves and nozzle bodies, which for instance are often located in the vehicle's propulsion or attitude control systems, can be subject to hot gas effluent that reaches extremely high temperatures. The temperature in rocket exhaust, for example, can reach levels greater than 5000 degrees F. Pressures in exhaust bodies can also exceed 1000 psi.

The operating conditions that hot gas valves experience can lead to serious amounts of stress and wear on the valve body and components. Various components of hot gas valves, and particularly valves used with rocket motors and gas generators, are subject to extremely high temperature, pressure, erosion, corrosion, and stress environments. One critical component in a hot gas valve is the seat or sealing face against which a poppet or mating face makes a seal. The seat must be able to withstand highly erosive flow, high mechanical loads, and thermal shock. However, many seat materials erode sufficiently during operation such that a good seal cannot be maintained. Alternatively, seats and valves can break due to mechanical and thermal loading.

Thus, material selection is an important criteria in designing valve components. Over the years, various materials have been identified which, to some extent, withstand the temperatures and stresses experienced by hot gas valves. However, these known materials, when used in a seat application, lack some desired qualities such as cost, weight, manufacturability, or durability. Rhenium, for example, is an expensive material to use in a valve seat application. It would be desired to identify a new material with improved qualities.

Hence there is a need for a hot gas valve that addresses one or more of the above-noted drawbacks. Namely, a hot gas valve and valve seat are needed that are constructed of a material that can better withstand the temperatures, thermal shock, mechanical loading, corrosion, erosion, degradation, and stress encountered during rocket firing and rocket travel to the upper atmosphere and space; and/or that can be adapted to known valve designs; and/or that may be easily manufactured; and/or that provides an acceptable seal during operation; and/or that can be manufactured and applied at a reasonable cost.

### SUMMARY OF THE INVENTION

The current invention provides a material and a valve seat constructed from the material that is an improvement over existing hot gas valves. Valve seats are constructed of a fibrous monolith ceramic material, including ZrC—BN—ZrC fibrous monolith ceramic. Other valve components such as poppets, balls, pintels, sealing surfaces, and mating surfaces may also be constructed of fibrous monolith ceramic.

In one embodiment, and by way of example only, a valve seat for use in a hot gas valve with exhaust from ammonium perchlorate rocket propellant is provided. The valve seat is comprised in whole or part of fibrous monolith ceramic, preferably ZrC—BN—ZrC fibrous monolith ceramic.

In another embodiment, a hot gas valve is provided that includes a hollow valve body allowing passage of hot gas through said valve body. A hollow valve seat is positioned on the valve body, and the valve seat is composed in whole or part of fibrous monolith ceramic. A mating face is positioned within said valve body such that the mating face is free to close against the valve seat or open by moving away from the valve seat. Preferably the valve seat is made in whole or part of ZrC—BN—ZrC fibrous monolith ceramic.

In a further embodiment, a hot gas valve is provided for use in porting rocket exhaust on a rocket vehicle. The hot gas valve includes a valve seat that is hollow and wherein the valve seat is composed substantially of fibrous monolith ceramic. The hot gas valve also includes a poppet that seals against the valve seat so as to restrict passage of exhaust through the valve. The poppet can open from the valve seat so as to allow rocket exhaust to port to the exterior of the rocket.

In still a further embodiment, a method of steering a rocket is disclosed that includes the steps of directing rocket exhaust to a valve. A further step includes moving a mating face of the valve away from a valve seat which is made in part of fibrous monolith ceramic, thus allowing exhaust to port through the valve to the exterior of the rocket. Then, the method includes closing the valve by pressing a mating face of the valve against a valve seat made in part of fibrous monolith ceramic. The act of porting rocket exhaust to the exterior of the rocket thereby imparts a steering force on the rocket vehicle.

Other independent features and advantages of the hot gas valve will become apparent from the following detailed description, taken in conjunction with the accompanying drawings which illustrate, by way of example, the principles of the invention.

### BRIEF DESCRIPTION OF THE DRAWINGS

FIG. 1 is a perspective view of a valve seat and poppet according to a hot gas valve embodied by the present invention.

FIG. 2a is a side view of one embodiment of a hot gas valve according to the present invention in the closed position.

FIG. 2b is a side view of one embodiment of a hot gas valve according to the present invention in the open position.

FIG. 3 is a perspective view of one embodiment of a hot gas valve seat.

FIG. 4 is a perspective view of a hot gas valve of the ball-and-raceway design that incorporates features of the hot gas valve.

FIG. 5 is a perspective view of a hot gas valve of the pintel-type design that incorporates features of the hot gas valve.

### DETAILED DESCRIPTION

Reference will now be made in detail to exemplary embodiments of the invention, examples of which are illustrated in the accompanying drawings. Wherever possible, the same reference numbers will be used throughout the drawings to refer to the same or like parts.

It has been found that valves may be constructed that better withstand the high temperatures associated with hot gas exhaust, such as that encountered in the exhaust of rocket engines. The advantage to the valves described herein derives from the material selected for the valve construction, and in particular, the material used to construct the valve seat.

In one embodiment, a sealing surface of a valve and a corresponding mating surface are positioned within a valve. The sealing surface is composed in whole or part of fibrous monolith ceramic. The mating surface may also be composed in whole or part of fibrous monolith ceramic. A sealing surface may correspond to a valve seat. A mating surface may correspond to a valve poppet. Typically the valve poppet is capable of moving between an open and a closed position. When the poppet is pressed against the valve seat, the valve is closed so that gases cannot pass through the valve to a substantial degree. When the poppet is moved away from the valve seat, gases are free to pass through the valve. Several specific kinds of valve designs can incorporate the above-described features of the hot gas valve.

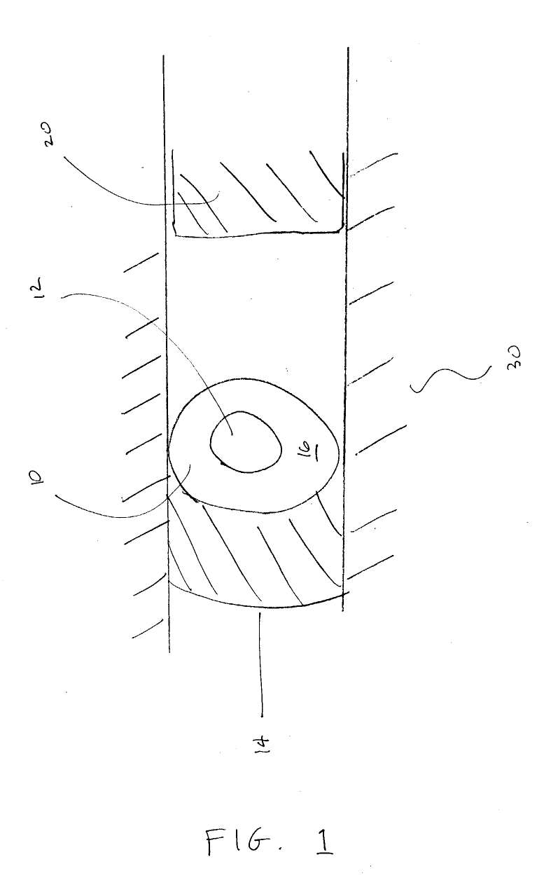

Referring to FIG. 1 there is shown a view of a hot gas valve seat constructed with fibrous monolith ceramic. Generally valve seat 10 comprises a hollow body through which fluids, such as combustion gases can flow. Valve seat 10 includes ingress 12 and egress 14. Face 16 at ingress 12 provides a surface at which to seal valve seat 10. Poppet 20 is positioned relative to valve seat 10 so that it is able to move from a position in contact with face 16 to a position not contacting face 16.

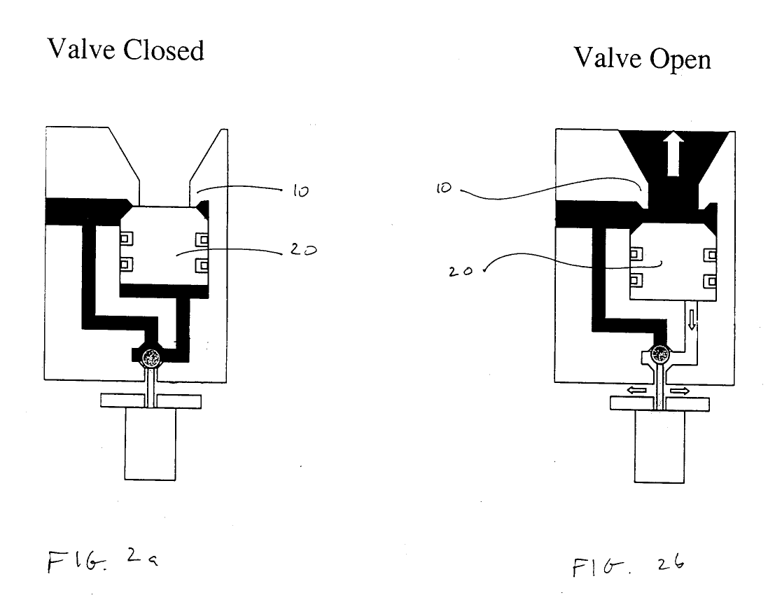

Valve seat 10 may take any of the known shapes and configurations so as to provide fluid passage. Likewise poppet 20 can take any of the known shapes and configurations. And, as is known in the art, other valve pieces may be attached to valve seat 10 and poppet 20. For example springs, seals, and pistons may be included in a hot gas valve. Seals are illustrated in FIGS. 2a and 2b as attached to poppet 20. Further valve seat 10 and poppet 20 may be positioned in a valve body 30 and further valve apparatus. Valve body 30 may take several shapes and sizes. It generally is hollow so as to permit the flow of gases. Valve body 30 may also provide an enclosure for valve seat 10 and/or poppet 20. Apertures or ingresses may be positioned so as to admit gas into the valve body.

The hot gas valve is constructed in whole or part of fibrous monolith ceramic, sometimes referred to as FMC. Preferably valve seat 10 is constructed, in whole or part, of fibrous monolith ceramic. Poppet 20 may also be constructed in whole or part of fibrous monolith ceramic. Sometimes in the literature, fibrous monolith ceramic is also referred to as fibrous ceramic or fibrous monolith composite.

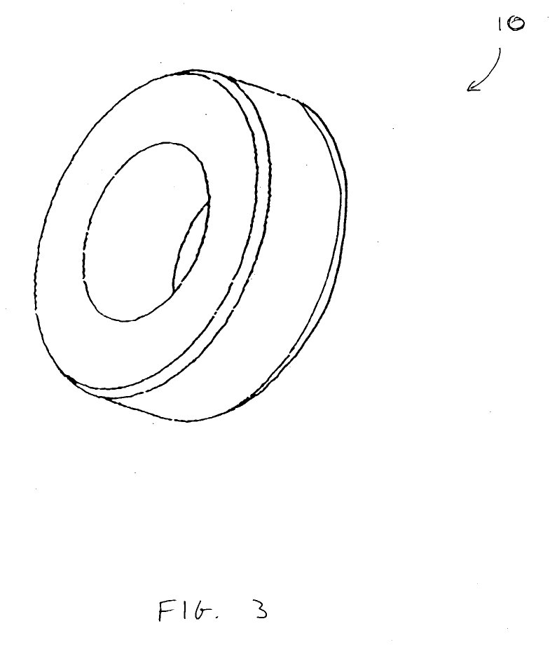

In a preferred embodiment, as shown in FIG. 3, valve seat 10 is a generally cylindrical body. Valve seat 10 is itself hollow or has an aperture through which gases may flow. A receiving notch or hole is formed in the rocket body to receive valve seat 10. Typically a receiving hole is machined or cast in the tail section of the rocket body, and valve seat 10 is affixed thereto. Valve seat 10 may be affixed to the rocket body by known methods including gluing, press fitting, or mechanically affixing (as with a retention bolt or ring) the valve seat to the body.

In operation, gases such as combustion gases may pass through valve seat 10. Poppet 20, when in contact with face 16 acts to restrict passage of gas flow through valve seat 10. While the hot gas valve generally restricts gas flow through the valve when closed, those skilled in the art will understand that a seal may not be perfect or absolute and that under high pressures some amount of gas flow may occur through the valve even when closed. One embodiment of the hot gas valve in the closed position is illustrated in FIG. 2a. When poppet 20 is moved to a position not in contact with face 16 gases are free to flow through valve seat 10. In this position, the valve is open, and an illustration of one embodiment of the hot gas valve in the open position is shown in FIG. 2b. During a typical rocket flight poppet 20 will engage and disengage with valve seat 10 numerous times. As part of the rocket's steering system, exhaust gases will be channeled through ingress 12 and egress 14 of valve seat numerous times.

Fibrous monolith ceramic is a term that describes a class of materials. The fibrous monolith ceramic materials that may be used in the hot gas valve are described in U.S. patent application Publication No. 2002/0154741, titled Composite Components for Use in high Temperature Applications, the contents of which are incorporated by reference herein. Various methods for preparing fibrous monolith ceramic are known in the art, including the methods disclosed in U.S. patent application Publication No. 2002/0154741 and U.S. Pat. No. 5,645,781, which are also incorporated by reference in their entirety. Fibrous monolith ceramics may be fabricated using commercially available powders.

Several specific compositions or formulations for fibrous monolith ceramic are known. Preferably, for applications involving the hot gas valve, a fibrous monolith ceramic with a ZrC—BN—ZrC composition is the material to be used. ZrC is zirconium carbide. BN is boron nitride. A ZrC—BN—ZrC fibrous monolith ceramic may be constructed in a honeycomb architecture.

Generally a fibrous monolith ceramic may be described as a ceramic and/or metallic composite material. The material may include a plurality of monolithic fibers, or filaments, each having at least a cell phase surrounded by a boundary phase, but may also include more than one core and/or shell phase. Materials fabricated of fibrous monolith ceramic display the characteristic of non-brittle fracture and are thus advantageous in applications that call for non-catastrophic failure. Fibrous monolith ceramic also display good characteristics related to mechanical properties, thermal shock resistance, thermal cycling tolerance, and strength at elevated temperatures. Select materials also perform well with respect to oxidation and corrosion resistance.

The cell phase of a fibrous monolith ceramic may include structural materials of a metal, metal alloy, carbide, nitride, boride, oxide, phosphate, silicide, or a combination thereof. The boundary phase is generally a weaker and more ductile material that surrounds the cell phase. BN, boron nitride, is one material that may be used to create the boundary phase. Fibrous monolith ceramics preferably are designed with a cell phase material that is different from the boundary phase material. This difference in materials leads to a difference in properties which also results in the advantageous macroproperties associated with the fibrous monolith ceramic.

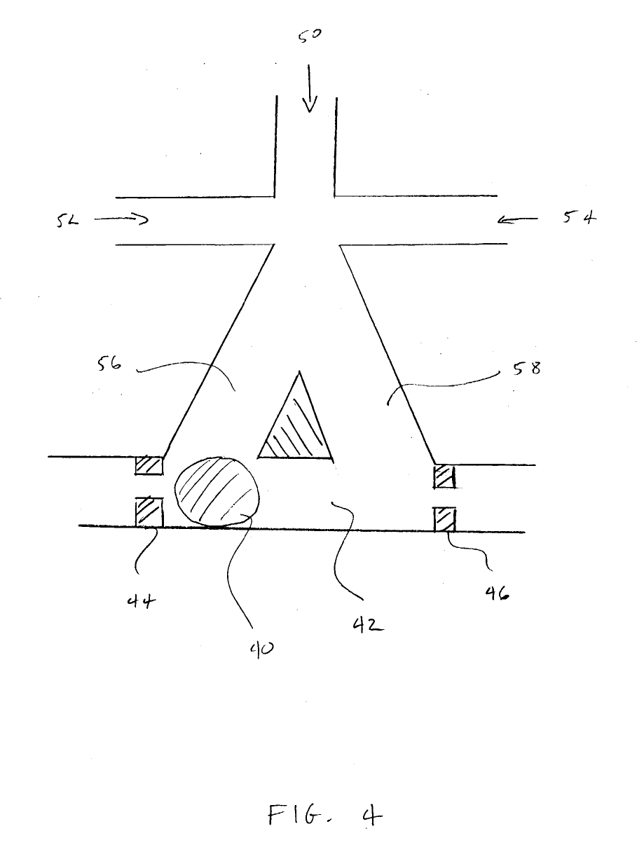

Referring now to FIG. 4 there is shown an embodiment of a ball valve that also includes features of the hot gas valve. Ball 40 is positioned within raceway 42. Raceway 42 is a passage of a size that allows ball 40 to move within raceway 42. When ball 40 is spherical in shape, raceway 42 will have a substantially hollow cylindrical shape to allow movement of ball 40 therein. Raceway 42 also permits the movement of gas through its cavity. While the ball valve is described herein as having a spherical ball 40 those skilled in the art will understand that a valve that uses the principles of the ball valve can also be constructed wherein a moveable object corresponding to the ball has a different shape. Thus, for example a moveable ball might actually be a pig or slug that is itself cylindrical in shape with rounded ends. Other configurations are also possible provided the ball is free to move within a corresponding raceway.

Referring still to FIG. 4 at opposite ends of raceway 42 are valve seats 44 and 46. Valve seats 44 and 46 include a sealing face (not shown) against which ball 40 can rest or press. Valve seats 44, 46 and sealing face thus provide a limit to the movement of ball 40 within raceway 42. Valve seats 44 and 46 include a hollow or aperture that allows gas to pass through said valve seat. When ball 40 rests against a sealing face, gas flow through that valve seat associated with the sealing face is restricted. When ball 40 moves away from a sealing face, gas is again allowed to pass through that valve seat.

In the ball valve that incorporates features of the hot gas valve, at least one of valve seats 44 and 46 are composed in whole or part of fibrous monolith ceramic. In a preferred embodiment, both valve seats 44, 46 substantially comprise ZrC—BN—ZrC fibrous monolith ceramic.

The ball valve described herein has been described as having two valve seats 44, 46 at opposite ends of raceway 42. However, other configurations of a ball-type valve that are known in the art include an inlet through which gas is admitted and an outlet through which gas exits. In that type of configuration a valve seat may be positioned only at the outlet wherein the valve seat is comprised of fibrous monolith ceramic or ZrC—BN—ZrC fibrous monolith ceramic, in whole or part.

Other features of a ball-type valve adapted to channel hot gas rocket exhaust are also illustrated in FIG. 4. While these features are preferred, it should be understood that other arrangements are also possible. Hot gas inlet 50 admits hot gas exhaust into the valve body. The valve body may be described as the structure that defines the raceway, channels, passageways, and inlets of the valve. It may be comprised of single or multiple pieces. Directional channels 52 and 54 also admit hot gas exhaust. For convenience channels 52, 54 may be referred to as left channel 52 and right channel 54. Below channels 52, 54 are directional passageways 56 and 58, which may also be referred to as a left 56 and right 58 directional passageway. Inlet 50, channels 52, 54, and directional passageways 56, 58 are in fluid communication with raceway 42.

Inlet 50 and channels 52, 54 receive hot gas from another location in the rocket engine. Other control mechanisms restrict the flow of gas through left and right channels 52, 54 so that gas is only significantly admitted through one of the channels, or through neither of the channels, at a given instant. Gas is not significantly admitted through both the left and right channels 52, 54 at the same time. When gas is admitted into the ball valve through inlet 50 and left channel 52, the resulting downstream gas travels significantly through right directional passageway 58. Conversely, when gas is admitted into the ball valve through inlet 50 and right channel 54, the resulting downstream gas travels significantly through left directional passageway 56. When gas passes through left directional passageway 56, the gas tends to force ball 40 away from left valve seat 44 and to press against right valve seat 46. In this position right valve seat 46 is sealed and gas exits the ball valve through left valve seat 44. Conversely, gas that passes through right directional passageway 58 tends to force ball 40 away from right valve seat 46 and to press against left valve seat 44. In this position, left valve seat 44 is sealed and gas exits the ball valve through right valve seat 46. It will be understood by those skilled in the art, that as gas exits either the left 44 or right 46 valve seat, the gas may be further directed so that the exiting gas tends to steer the craft in a desired direction. For example the gas may be ported to the exterior of the vehicle through a nozzle.

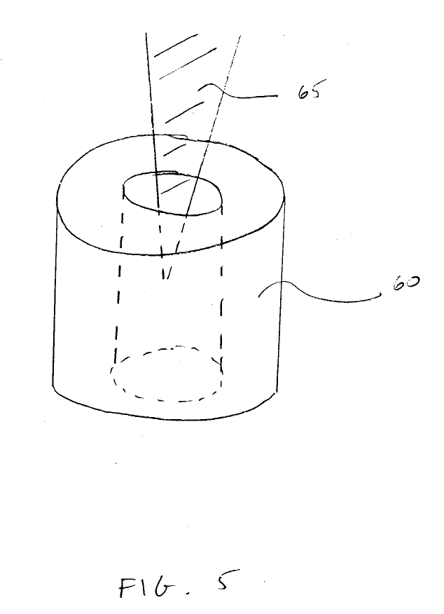

Referring now to FIG. 5 there is shown a further embodiment of the hot gas valve. The valve shown in FIG. 5 may be described as a pintel valve. A pintel valve includes valve seat 60 and pintel 65. Preferably valve seat 60 is comprised in whole or part of fibrous monolith ceramic. Valve seat 60 is generally hollow, and the hollow area can allow gases to pass through valve seat 60. Pintel 65 can assume various shapes. Preferably pintel 65 has a cross sectional shape that corresponds to the cross sectional area of valve seat 60. Pintel 65 is free to move in an axial direction with respect to the hollow area of valve seat 60. At one end of its movement, pintel 65 engages valve seat 60. At this point gas flow through valve seat 60 is restricted; this is the closed position. As pintel 65 moves away from the closed position, the area through which gas may flow increasingly opens. Thus the position of pintel 65 with respect to valve seat 60 acts as a flow control valve. At the opposite end of its motion, pintel 65 is in the fully open position. More gas is allowed to flow through pintel valve as pintel 65 moves from the closed to a more open position.

The valves described herein may be used with rocket propellants. Ammonium perchlorate is one such rocket propellant that is currently in wide use. The valves described herein may be used with ammonium perchlorate propellants. The valves may also be used with solid fuel rocket propellants generally. Aluminized rocket propellants may also be used with the valves described herein. Liquid fuel propellants may also be used with the hot gas valve. It may be advantageous, particularly for those liquid fuels with high burn temperatures, to use the hot gas valve.

Thus, it has been found that valves may be constructed that better withstand the high temperatures associated with hot gas exhaust, such as that encountered in the exhaust of rocket engines. The advantage in terms of cost, durability, erosion resistance, corrosion resistance, thermal shock resistance, and mechanical shock resistance that is obtained results from the material that the valve is made of, and in particular the material that the valve seat is made of. However, this material selection was realized after a testing campaign and analysis of numerous potential materials. The testing and evaluation that have gone into the selection of the preferred material for the hot gas valve have lasted four years and required an investment in the order of several hundreds of thousands of dollars.

Numerous refractory carbides were analyzed and tested for their suitability as a material for hot gas valve seats. Among the materials analyzed and tested were Tungsten Carbide, Tantalum Carbide, Silicon Carbide, and Hafnium Carbide. Metallic Rhenium was also considered as a material for use in valve seats. Rhenium, however, is generally a comparatively expensive material.

Initially thermodynamic modeling was used to evaluate several potential materials. The thermodynamic modeling employed a software known as Facility for the Analysis of Chemical Thermodynamics (FACT). FACT is offered through McGill University of Canada. The thermodynamic modeling identified several materials, including Rhenium, Zirconium Carbide, Hafnium Carbide, and Tantalum Carbide that could provide good erosion resistance. These materials were further tested to evaluate their performance.

Samples were made in the shape of a coated nozzle throat. Sample nozzles were constructed using coatings on graphite of rhenium, zirconium carbide and tantalum carbide. At this testing, the materials were tested as a coating on a carbon or graphite substrate. Hot gases were passed over the nozzle samples to simulate a rocket firing. A liquid propellant was used to provide temperatures approximating 5000 degrees F at approximately 1200 psi for 7 seconds exposure at mach 1 flow. The nozzles constructed of Zirconium Carbide and Rhenium displayed generally equivalent performance with respect to erosion properties, as coatings. Zirconium Carbide, however, is generally a less expensive material than Rhenium. Zirconium Carbide thus represented a possible design alternative to Rhenium.

The concept of using Zirconium Carbide (ZrC) as a structural or monolithic material for a valve seat, as opposed to merely as a coating material, required further investigation. While the previous testing had indicated that ZrC as a coating showed erosion resistance, that did not suggest the material should be considered as a structural material. Zirconium Carbide is a ceramic material. Generally ceramic materials, including Zirconium Carbide, are brittle. It was uncertain that this material could provide the strength or durability needed for application in a hot gas valve. It was believed that structural ZrC may not resist thermal shock well in a high thermal shock environment. Strain relief and strain control were seen as limiting the structural applicability of this material. The conductivity, specific heat, and coefficient of thermal expansion that were known for this material in solid form are favorable to those of some carbides that demonstrate poor thermal shock resistance, but it was not known if those properties would be suitable in the high thermal shock environment of a hot gas valve. The conductivity, specific heat, and coefficient of thermal expansion for ZrC were not as good as those properties for other materials that were known to perform well in a high thermal shock environment. Thus ZrC structure had previously not been considered as suitable for use in a hot gas valve environment.

Further investigation and experimentation was performed to determine whether ZrC could be coupled with another material in order to provide a composite material useful in structural applications. Several additional materials were considered. Boron Nitride, BN, was seen as a candidate material that could provide good strain control. However, it was unclear whether BN would be a stable material at the temperatures and pressures experienced in the environment of hot rocket gas. A thermodynamic test using FACT software was performed. One result of this test indicated that BN would react with exhaust gas produced from a rocket propellant such as ammonium perchlorate. Thus it was uncertain how BN could be used in a hot gas valve structure.

It was then further conceived that BN could be combined with ZrC in a fibrous monolith ceramic so that the ZrC phase tended to isolate the BN phase from exposure to the rocket exhaust. However, it was now unclear whether this material would provide the combination of properties necessary to function successfully as a hot gas valve. The composite material would have to provide the needed mechanical properties and thermal shock properties while maintaining structural integrity under high temperature and pressure.

A valve seat was constructed of ZrC—BN—ZrC. The valve seat was subjected to a test firing under conditions approximating those encountered in a rocket using ammonium perchlorate propellant. The tests confirmed that ZrC—BN—ZrC fibrous monolith ceramic provided improved performance as a hot gas valve seat.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1-18 (canceled)

19. A method of steering a rocket comprising:
directing rocket exhaust to a valve;
moving a mating face of said valve away from a valve seat made it part of fibrous monolith ceramic; and
pressing a mating face of said valve against a valve seat made in part of fibrous monolith ceramic.

20. The method of claim 19 further comprising porting rocket exhaust to the exterior of said rocket thereby imparting a steering force on said rocket.

21. The method of claim 19 wherein said valve seat comprises in part ZrC—BN—ZrC fibrous monolith ceramic.

22. The method of claim 19 wherein said exhaust is exhaust from ammonium perehorate fuel.

23-27 (canceld)
